(19) United States
(12) Patent Application Publication
(10) Pub. No.: US 2006/0010058 A1
(43) Pub. Date: Jan. 12, 2006

(54) Multidimensional database currency conversion systems and methods

(75) Inventors: Thierry D'Hers, Redmond, WA (US); Aleksandar Juric, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/131,631

(22) Filed: May 18, 2005

Related U.S. Application Data
(63) Continuation-in-part of application No. 11/054,803, filed on Feb. 10, 2005.
(60) Provisional application No. 60/586,644, filed on Jul. 9, 2004.
(60) Provisional application No. 60/586,586, filed on Jul. 9, 2004.

(51) Int. Cl. G06Q 40/00

(52) U.S. Cl. 705/35

(57) ABSTRACT

The subject invention pertains to generation of a support structure for currency conversion. More specifically, systems and methods are disclosed to generate a currency conversion infrastructure automatically. Users can be queried and specify currency conversion parameters and configuration in business terms without specific knowledge of technical implementation details. The systems and methods retrieve the business term answers and translate them into a corresponding currency conversion system by generating one or more of technical schemas, data, logic, rules, views, and dimensions.

### CROSS-REFERENCE TO RELATED APPLICATIONS

This application claims the benefit of U.S. Provisional Application Ser. No. 60/586,586, filed Jul. 9, 2004, entitled SYSTEMS AND METHODS OF CUSTOMIZING DATABASES. This application is also a continuation-in-part of U.S. application Ser. No. 11/054,803, filed Feb. 10, 2005, entitled CUBE UPDATE TOOL, which claims the benefit of U.S. Provisional Application Ser. No. 60/586,644, filed Jul. 9, 2004, entitled SYSTEMS AND METHODS THAT FACILITATE SOLVING BUSINESS PROBLEMS. The entireties of these applications are incorporated herein by reference.

### COPYRIGHT NOTICE

A portion of the disclosure of this patent document contains material, which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### TECHNICAL FIELD

The subject invention relates generally to multidimensional database systems and more particularly toward currency conversion.

### BACKGROUND

Data warehousing and online analytical processing (OLAP) are widespread technologies employed to support business decisions and data analysis. A data warehouse is a nonvolatile repository for an enormous volume of organizational or enterprise information (e.g., 100 MB-TB). These data warehouses are populated at regular intervals with data from one or more heterogeneous data sources, for example from multiple transactional systems. This aggregation of data provides a consolidated view of an organization from which valuable information can be derived. Though the sheer volume can be overwhelming, the organization of data can help ensure timely retrieval of useful information.

Data warehouse data is often stored in accordance with a multidimensional database model. Conceptually in multidimensional database systems, data is represented as cubes with a plurality of dimensions and measures, rather than relational tables with rows and columns. A cube includes groups of data such as three or more dimensions and one or more measures. Dimensions are a cube attribute that contains data of a similar type. Each dimension has a hierarchy of levels or categories of aggregated data. Accordingly, data can be viewed at different levels of detail. Measures represent real values, which are to be analyzed. The multidimensional model is optimized to deal with large amounts of data. In particular, it allows users execute complex queries on a data cube. OLAP is almost synonymous with multidimensional databases.

OLAP is a key element in a data warehouse system. OLAP describes a category of technologies or tools utilized to retrieve data from a data warehouse. These tools can extract and present multidimensional data from different points of view to assist and support managers and other individuals examining and analyzing data. The multidimensional data model is advantageous with respect to OLAP as it allows users to easily formulate complex queries, and filter or slice data into meaningful subsets, among other things. There are two basic types of OLAP architectures MOLAP and ROLAP. MOLAP (Multidimensional OLAP) utilizes a true multidimensional database to store data. ROLAP (Relational OLAP) utilizes a relational database to store data but is mapped so that an OLAP tool sees the data as multidimensional. HOLAP (Hybrid OLAP) is an amalgam of both MOLAP and ROLAP.

Data cube cells (and similarly members and the like) can include either fact data or functions (also referred to as calculations, expressions . . . ). Cells that include functions are called calculated cells. The value of these cells is defined by an expression in terms of one or more other cells and mathematical operations. The actual values of such cells are not known until runtime when the expressions or calculations are resolved. The formulas or expressions are defined and assigned to cells utilizing a calculation script, for example specified in a multidimensional language such as MDX (MultiDimensional expressions)

Due to the complexity of data storage one must have substantial knowledge of data structures and be highly skilled in many areas to be able generate, manipulate, update and query a data store. Accordingly, one or more expert computer programmers and/or data analysis experts are typically required to set-up, update, and modify data stores. Additionally, these tasks can require a substantial amount of time (e.g., for coding, development, testing . . . ), even with respect to one of utmost skill. Accordingly, cost, in terms of both time and money, can become significant and possibly prohibitive to a user and/or entity seeking to employ such database systems.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Briefly described the subject invention pertains to currency conversion systems and methods. More particularly, the invention concerns generation of the infrastructure to support currency conversions. In accordance with an aspect of the subject invention, currency parameters and options can be specified by querying a user in business terms and receiving answers in business terms. These business answers can then be translated automatically into technical supporting infrastructure including but not limited to schemas, data, logic, rules, and multidimensional objects. In this manner, users are relieved of the tremendous burden of building all the objects, dimensions, and logic, among other things, manually. The disclosed systems and methods facilitate such a process and produce a highly optimized and efficient infrastructure in a fraction of the time it would take to generate a much less efficient system manually.

In accordance with an aspect of the invention, a wizard is provided to facilitate querying users and retrieving data therefrom. The wizard can walk the user through steps and query them for required information concerning currency conversion in simple business terms. For example, the wizard can request and receive the location of an exchange rate, the identity of the data units to which the rate is to be applied, and the type or currency conversion to be employed. Furthermore, the wizard can request and receive the manner in which the local currency is referenced and desired reporting currencies. Based on the input to the wizard, specific logic (e.g., MDX script) and data source views, among other things, can be generated or modified.

According to an aspect of the invention, the currency conversion logic and structures can go beyond a simple add on tool and be incorporated as part of built in server behaviors.

According to another aspect of the invention, the currency conversion systems can be generated to support currency simulation, for example, for cash flow simulations and the like.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

FIG. 1 is a block diagram of a currency conversion system is depicted in accordance with an aspect of the subject invention.

FIG. 2 is a block diagram of an interface component in accordance with an aspect of the subject invention.

FIG. 3 is a block diagram of a conversion component in accordance with an aspect of the subject invention.

FIG. 4 is an illustration of an exemplary graphical user interface in accordance with an aspect of the subject invention.

FIGS. 5a-c are illustrations of an exemplary graphical user interface to specify members to be converted in accordance with an aspect of the subject invention.

FIG. 6 is an illustration of an exemplary graphical user interface to enable specification of conversion type in accordance with an aspect of the subject invention.

FIGS. 7a-b are illustrations of an exemplary graphical user interface to facilitate definition of a local currency reference in accordance with an aspect of the subject invention.

FIG. 8 is an illustration of an exemplary graphical user interface to facilitate identification of reporting currencies in accordance with an aspect of the subject invention.

FIG. 9 is an illustration of an exemplary graphical user interface for dealing with existing script in accordance with an aspect of the subject invention.

FIG. 10 is a block diagram of a currency conversion system in accordance with an aspect of the subject invention.

FIG. 11 is a block diagram of an interface system in accordance with an aspect of the subject invention.

FIG. 12 is a flow chart diagram of a currency conversion methodology in accordance with an aspect of the subject invention.

FIG. 13 is a flow chart diagram of an interface methodology in accordance with an aspect of the subject invention.

FIG. 14 is a flow chart diagram of a currency conversion methodology in accordance with an aspect of the subject invention.

FIG. 15 is a schematic block diagram illustrating a suitable operating environment in accordance with an aspect of the present invention.

FIG. 16 is a schematic block diagram of a sample-computing environment with which the present invention can interact.

### DETAILED DESCRIPTION

The present invention is now described with reference to the annexed drawings, wherein like numerals refer to like or corresponding elements throughout. It should be understood, however, that the drawings and detailed description thereto are not intended to limit the invention to the particular form disclosed. Rather, the intention is to cover all modifications, equivalents, and alternatives falling within the spirit and scope of the present invention.

As used in this application, the terms “component,” “system,” “engine” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the present invention may be implemented as a method, apparatus, or article of manufacture using standard programming and/or engineering techniques to produce software, firmware, hardware, or any combination thereof to control a computer to implement the disclosed invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the subject invention.

Artificial intelligence based systems (e.g., explicitly and/or implicitly trained classifiers) can be employed in connection with performing inference and/or probabilistic determinations and/or statistical-based determinations as in accordance with one or more aspects of the subject invention as described hereinafter. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject invention.

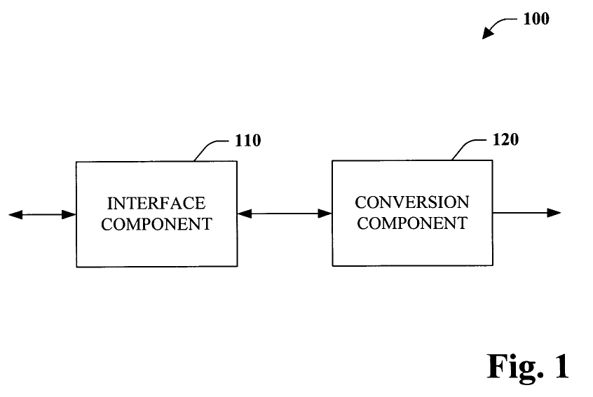

Turning initially to FIG. 1, a currency conversion system 100 is illustrated in accordance with an aspect of the subject invention. System 100 includes an interface component 110 and a conversion component 120. Interface component 110 receives input from users or other entities regarding conversion of currency. More specifically, interface component 110 can request and subsequently receive information from users. Information can be requested in familiar business terms as well as received in business terms rather than implementation specific technical terms. Interface component 110 is communicatively coupled to and can interact with conversion component 120. Conversion component 120 can receive input from the interface component 110 and generate and/or modify an infrastructure to support currency conversion. The conversion component 120 can convert the received business term responses into, among other things, technical data, logic, rules, schemas, multidimensional objects, and/or a combination thereof. Furthermore, the conversion component 120 can also interact with the interface component 110 such that it can request and receive specific information from a user or other source or otherwise influence the requests generated by the interface component 110. However, it should be appreciated that conversion component 120 can also infer, as that term is defined herein, some required input from context including but not limited to previous input, data, and/or data structure(s).

In accordance with an aspect of the invention, it should be appreciated that system 100 can provide for currency conversion with respect to an OLAP system or engine and more specifically with respect to a multidimensional OLAP engine, a multidimensional database management system, or portions thereof. In particular, system 110 can be incorporated into a multidimensional OLAP engine, for example, to facilitate design and/or update of a database, data warehouse, or structures comprising a database or data warehouse (e.g., multidimensional objects, cubes . . . ).

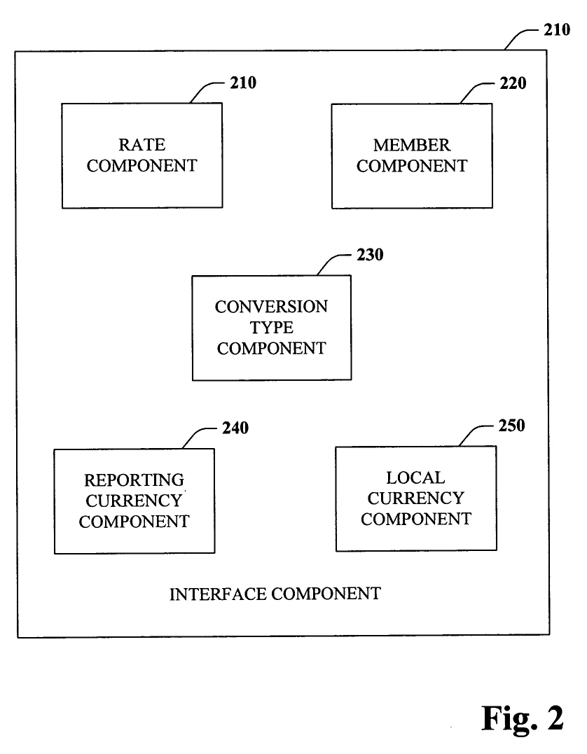

FIG. 2 illustrates an interface component 210 in further detail in accordance with an aspect of the subject invention. Interface 210 can include a number of components or subcomponents including rate component 210, member component 220, conversion type component 230, reporting currency component 240, and local currency component 250. Rate component 210 is a mechanism for requesting and/or retrieving rate information and/or the location thereof. Rate information identifies the currency rate or exchange rate between two currencies. The rate specifies how much one currency is worth in terms of another currency. The rate component can request or receive specific rates or the location of such rates. In accordance with an aspect of the invention, one or more rates can be stored and updated on a database. Hence, the information received could identify this database location. Data rates could also be provided by web service or the like. Accordingly, the rate component could receive information referencing the service (e.g., URL . . . ). Rate component 210 can also request and receive or otherwise determine or infer how the rates are given or entered (also referred to herein as the pivot currency). For example, does the rate pertain to conversions between euros to U.S. dollars, from U.S. dollars to euros, from Canadian dollars to euros, etc? Further yet, the rate component 210 can request and receive or otherwise determine or infer how the rate is to be applied to target currencies. For example, should a value be determined by multiplying a target currency by the exchange rate or by dividing the target currency by the rate?

Member component 220 can request and receive or otherwise retrieve the data units (e.g., multidimensional database objects, measures, dimensions . . . ) or identification thereof to be converted. Not all data in a system will need to or even be able to be converted properly. For example, some units of inventory or the like would not be subject to currency conversion. Accordingly, a determination has to be made as to what data will be converted. In accordance with one aspect of the invention, a user can be queried for a list of measures or members or other multidimensional data base objects or attributes in the system that need to be converted. For example, measures or accounts in a user chart of accounts could be specified to be converted. An account type could also be specified such as balance, asset, and liability accounts and the member component 220 could identify those data members that correspond to those types. Furthermore, the member component 220 could facilitate identification of units subject to conversion by presenting a list of potential units for conversion and allowing a user to select units to be converted therefrom.

Conversion type component 230 requests and receives the type of conversion that is to be performed. There are several different conversion types including but not limited to many-to-one, one-to-many, and many-to-many. The many-to-one type specifies conversion from several source currencies referenced as local currencies to a common currency reference as the corporate currency, for instance. By way of example, there is an international company where the corporate currency is the U.S. dollar. However, the company will receive data from a myriad of different countries in their local currency such as German and France in euros, Japan in yen, and Canada in Canadian dollars. In a many-to-one type conversion all this different currencies will be converted into one currency, in this example the corporate currency in U.S. dollars. A one-to-many type conversion specifies conversion from a common currency, such as the corporate currency, into multiple currencies such as reporting currencies. By way of example, if a large international company in Germany that tracks sales in euros does a large part of there business in several countries, it is likely that the company would desire to view sales in the local currency of such countries. A many-to-many type conversion is a combination of the many-to-one and one-to-many types whereby a number of number of source currencies can be converted into a plurality of reporting currencies. The conversion type component 230 can request or query a user and receive input specifying the type of conversion desired.

Reporting currency component 240 can request and receive or otherwise retrieve one or more reporting currencies to be utilized in a conversion. In a one-to-many or many-to-many type conversion, the reporting currencies need to be specified. In accordance with an aspect of the invention, a user can be presented with a list of available currencies from which reporting currencies can be specified. These available measures can be defined in a rate measure group in cube, for example.

Local currency component 250 can request and receive or otherwise retrieve a local currency. For many-to-one or many-to-many conversion types a local currency should be identified pertaining to how each transaction has been initially recorded in each of the local currencies. The currency could be recorded as part of a transaction itself. For instance, the currency code appears in a fact table. In other words, each transaction will be tagged with a currency code. This can be the case in sales or banking applications where business is conventional done with respect to multiple currencies regardless of the location of the institution. Additionally or alternatively, the currency can be assumed or inferred based on the origin of the data. The origin of the data can be identified as a member of another dimension (e.g., country, organization, department . . . ). The currency can be defined as a property of each member from such a dimension rather than appear in the fact table. Such can be the case with respect to financial applications. By way of example, assume there is a multinational company in the United States with subsidiaries all over the world. The company would receive profit and loss data from each subsidiary in its local currency, for instance France would transmit data in euros. The currency would not be converted at the source because France operates in euros. There likely would not be a currency code or tag associated with transactions in such a scenario. The currency can be assumed or inferred from the origin of the transaction. For example, there can be a currency code associated with a property of the subsidiary and the input provide by the local currency component can identify the location of that currency code. Determination of the local currency can be binary in nature such that local currency is identified as a transaction tag or as a property of a member. Alternatively, the local currency can be determined on a per account, measure or other unit basis. Thus, some member's local currency can be defined by the transactions and others can be the defined by a member property.

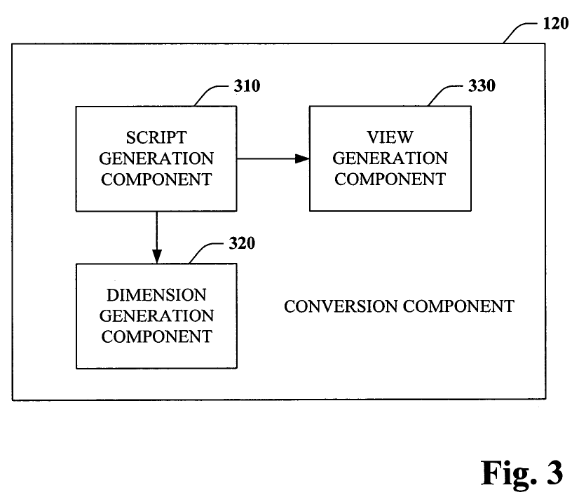

FIG. 3 illustrates a conversion component 120 in accordance with an aspect of the subject invention. Conversion component 120 can receive conversion parameters and/or options and includes a script generation component 310, dimension generation component 320 and view generation component 330. Script generation component 310 generates or produces a script to effectuate currency conversion in accordance with the received parameters. Such script can be an MDX script that operates on or in conjunction with a multidimensional data object such as cube. The script can specify the logic to construct a currency conversion infrastructure. The script is directly dependent and dynamically formed at design time based on the input received from a user, for instance, via interface component 110 (FIG. 1). Dimension component 320 can generate or produce a new cube dimension as well as populate such a dimension with currencies. View generation component 330 is a mechanism that generates new views in a data source view in order to create a record for each reporting currency member. View generation component 330 can be employed in the case where the conversion type corresponds to a one-to-many or many-to-many type. It should be appreciated that the script generated by script generation component 310 can specify the generation of one or more dimensions or views as described with respect to dimension generation component 320 and view generation component 330.

Conversion component 120 can generate scripts and create or add additional views within a few seconds or less upon receipt of currency conversion parameters. A cube can subsequently be populated with all the computations or logic necessary to support currency conversion and applications requiring conversion data. If one was to attempt to construct the require logic manually it would take them days to write the cube, test and debug such code. Furthermore, it would be unlikely that such an efficient and optimize conversion could be generated by someone other than an absolute expert in currency conversions, multidimensional objects such as cubes, and multidimensional scripts.

It should be appreciated that the conversion system 100 (FIG. 1) can be employed as a currency simulation system according to an aspect of the invention. In a basic scenario, the system can generate some converted values by multiplying or dividing some data by a rate. In a simulation situation, a plurality of rates can be specified, received or retrieved with respect to members. This can enable one to view data converted at various rates such as today's rate, a budgeted rate, or an anticipated rate. This is especially important in countries where their local currency fluctuation significantly. Such fluctuation creates cash flow problems when trying to budget and forecast, among other things, as the balance sheet numbers such as profit and loss vary enormously on the international market based on the variation of the currency value.

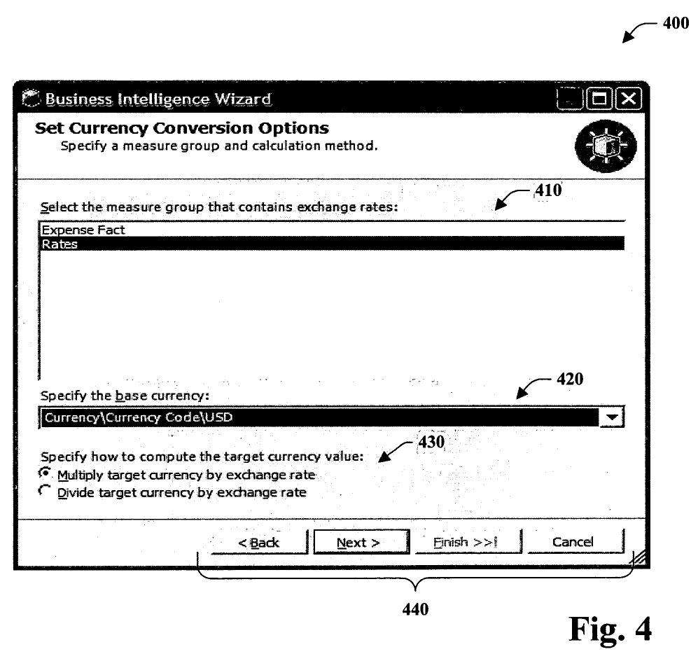

According to aspect of the subject invention, a wizard can be employed by or embody interface component 110 (FIG. 1) to facilitate retrieval of currency conversion information. A wizard is a user interface (e.g., GUI) that guides a developer through a sequence of steps, wherein each step should be completed before advancing to the next step in the series unless the step is optional, of course. FIGS. 4-9 illustrate portions of an exemplary wizard. Each figure depicts a GUI that includes a plurality of related images and interface objects or elements to facilitate retrieval of conversion parameters and/or options. For example, an interface can include any combination of, among other things, text, text boxes, drop down menus, checkboxes, and buttons which can be interacted with utilizing one or more of a pointing device (e.g., stylus, mouse, trackball, touchpad . . . ), keyword, or voice activated software. It should be noted, however, that these illustrations are provided by way of example and not limitation. As one of skill in the art can appreciate, there is a plethora of ways to arrange and present objects and text of graphical user interfaces. The depicted GUIs illustrate only one such arrangement and are presented for purposes of clarity and understanding and not to limit the scope of the subject invention to that which is disclosed.

FIG. 4 depicts an exemplary graphical user interface 400 in accordance with an aspect of the subject invention. Interface 400 is provided to set currency conversion options including measure group and calculation method specification. Interface 400 includes a measure group list box 410. This box 410 identifies all available measure groups in the current cube that have a currency dimension (e.g., dimension type property=Currency) in their dimensionality. In other words, box 410 presents a list of groups that contain exchange rates that can be selected. By default, the first group can be selected. A user can select from amongst the listed groups to specify an exchange rate to be utilized in a conversion. Although not illustrated, a checkbox can also be provided that upon selection filters the list of measure groups displayed in box 410 to show only exchange rate measure groups (e.g., property type set to Exchange Rate). Interface 400 also includes a drop down list 420, which is populated with the currency hierarchies (i.e., pivot currency) from the currency dimension(s) that dimensions the selected rate measure group. By default, the first attribute hierarchy is selected. Here, the selected base or pivot currency is U.S. dollars. Radio buttons 430 provide a mechanism to specify how to compute the target currency value. In particular, two checkboxes are provided the first specifying that the target currency should be multiplied by the exchange rate and the second specifying that the target currency should be divided by the exchange rate. By default, the multiply option can be selected and the user can change the option to divide if they desire. This mainly influences the script formula generated. Interface 400 can also include navigational buttons 440 for moving back or to the next interface, finishing, or canceling the process. Here, the back button could initiate movement to the last interface such as a welcome interface window. The next button can move to the next interface, described supra. The finish button has been disabled, as the process cannot yet be completed.

It should also be appreciated that warning messages can be displayed. If no currency dimension can be found in any measure group then the list box 410 and drop down list 420 would be empty and a warning message is displayed such as “A Rate measure group must be dimensioned by a currency dimension (Dimension type property set to Currency). No such measure group can be found.” An additional condition the wizard can check for is the presence of a time dimension (e.g., type property of dimension is set to Time). If a time dimension cannot be located that a warning message can be displayed, the Next button disabled and a messaged displayed such as “The wizard cannot continue because no dimension of type Time was found to be related to the exchange rate measure group.”

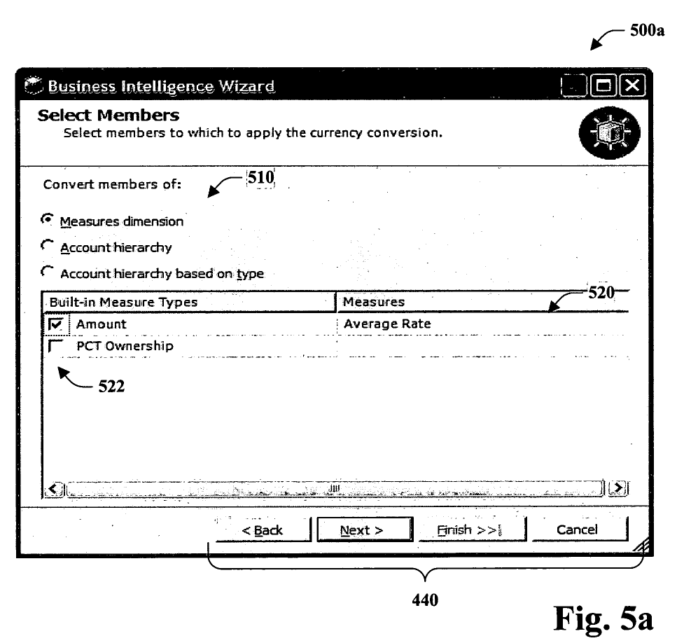

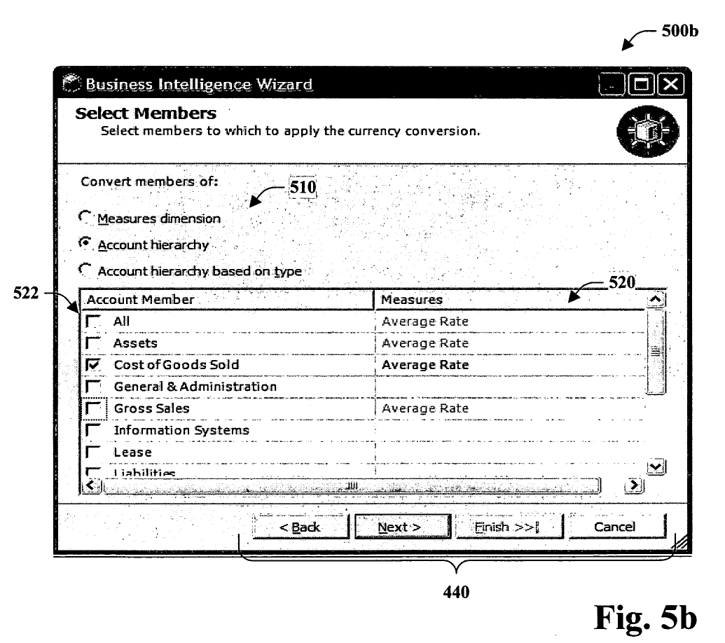

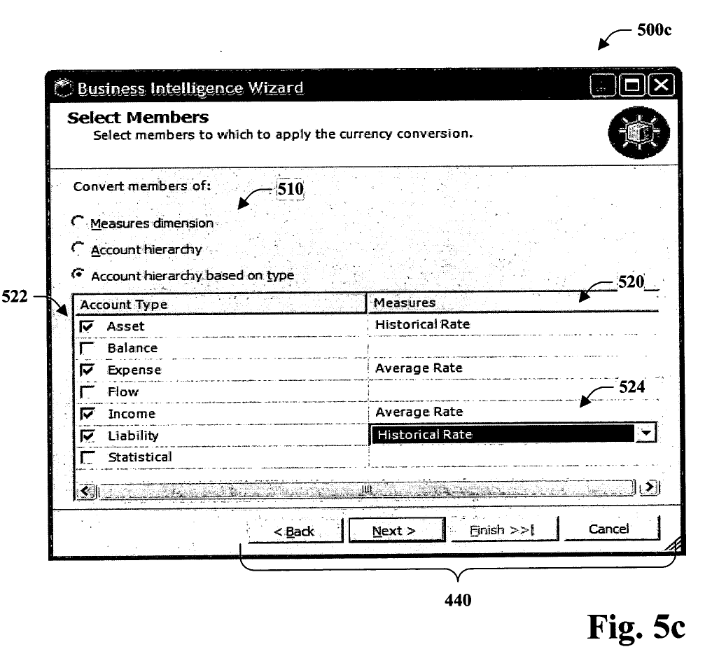

FIG. 5a illustrates an exemplary graphical user interface 500a to select members to be converted in accordance with an aspect of the subject invention. Interface 500a includes radio buttons 510 to select members to convert namely measures dimension, account hierarchy and account hierarchy by type. Grid 520 can display specific information based on the radio button or members selected there from. Interface 500a illustrates a scenario in which the member selected is the measures dimension. Consequently, a list of measures and types are displayed in grid 520. Furthermore, the list can include checkboxes 522 to allow a user to select measures with specificity. Interface 500b of FIG. 5b illustrates a case where account hierarchy is selected as the measure to be converted. Here, grid 520 displays the account members and their measures. Furthermore, checkboxes 522 as associated with the account members to facility selection of specific accounts. Interface 500c of FIG. 5c depicts a situation where the account hierarchy based on type option is selected. In this scenario, the grid 520 can display account types and measures. In addition, the rate measure column can include a drop down menu 524. The drop down menu or list 524 contains all the measures contained in the rate measure group previously selected with respect to interface 400 (FIG. 4). A user can thus select a specific rate measure associated with the account type to be converted. Each of the different interfaces 500a, b or c all also include navigational buttons 440 to move back to the previous interface, move forward to the next interface, or cancel the process. The finish button is disabled, as the process is not able to complete at this point. It should be appreciated that if an account dimension were not detected amongst the dimensions of the cube, then the last two radio button 510 options would be unavailable and grayed out to indicate this fact. If an account type were not detected then the very last options would not be available and would be grayed out to designate this fact.

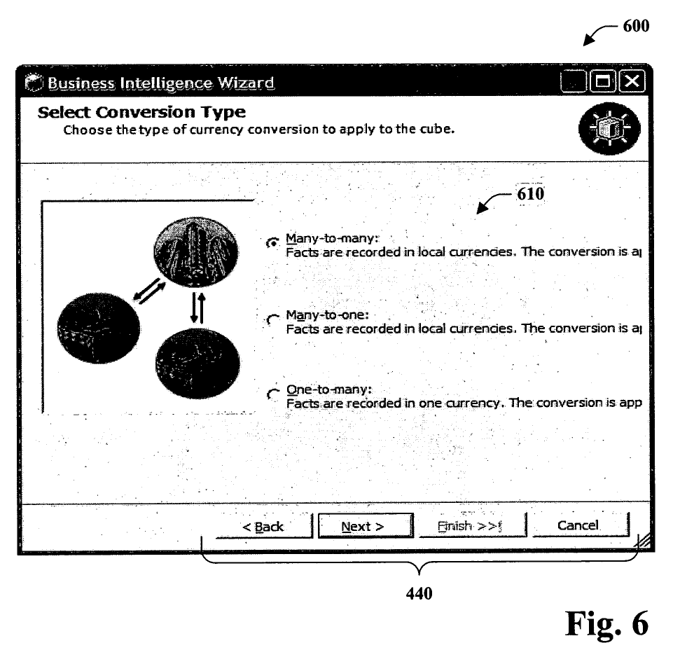

FIG. 6 illustrates an exemplary interface 600 to enable specification of conversion type in accordance with an aspect of the subject invention. Amongst other graphics, interface 600 can include a list of radio buttons 610 that correspond to a conversion type. In particular, there are three radio buttons 610 to facilitate specification of a many-to-many, many-to-one, or one-to-many conversion type. In addition, the interface 600 can include navigational buttons 440 that provide a mechanism to move back to the previous interface, move forward to the next interface in the wizard, or cancel the process. The finish button is disabled, as the process cannot yet be finished.

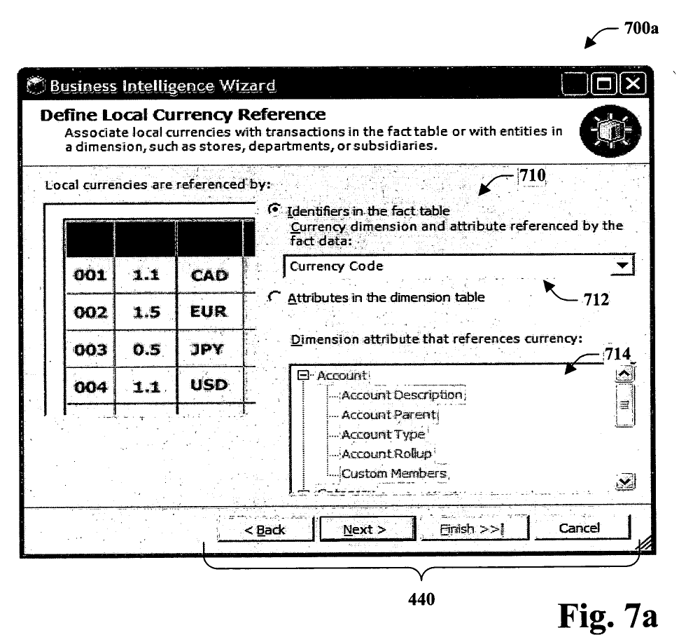

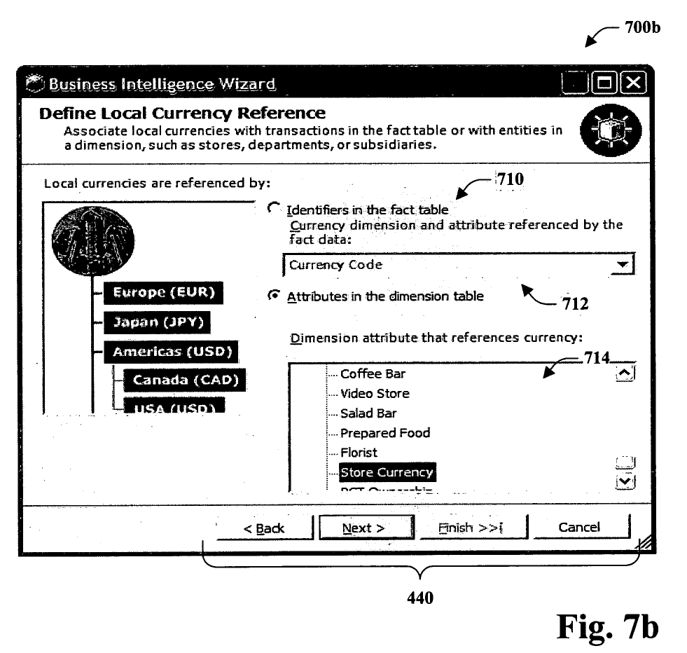

FIGS. 7a and 7b depicts exemplary interfaces 700a and 770b to facilitate definition of a local currency reference in accordance with an aspect of the subject invention. Interfaces 700a and 700b, amongst other graphics, include radio buttons 710 to identify how currencies are referenced, as well as a drop down menu or list 712 and a window 714. The interfaces enable specification of local currencies in as identifiers in the fact table or with entities in a dimension table such as stores, departments or subsidiaries. Interface 700a illustrates the scenario in which identifiers in the fact table are selected. Drop down menu 712 lists every valid currency dimension and their attribute that are part of the dimensionality of the measure group of selected measures or accounts or account types. This can be found as follows:

For each selected measure, look at their measure group dimensionality and select every currency typed dimension. For each currency dimension, select attributes whose members can be mapped to Rate measure group attribute members.

For selected account, look at the account dimension in which they belong. Find the measure group reference for those account dimensions. For those measure group, look at their dimensionality and select every currency typed dimension. For each currency dimension, select attributes whose members can be mapped to Rate measure group attribute members.

For selected account type, determine which account dimension has an “account type” typed attribute. Find which measure group that references those account dimensions. For measure group, analyze their dimensionality and select every currency typed dimension. For each currency dimension, select attributes whose members can be mapped to rate measure group attribute members.

Valid means that the currency dimension is tagged with the type of the currency and one of its attributes contain member names that also appear in the Rate measures group currency dimension attribute selected via the first interface presented.

There can be special cases. For example, if the currency dimension used by every measure group that contains selected measure or account members is the same dimension (e.g., same object) as the currency dimension used in the rate measure group, then the drop down menu 712 is disabled and populated with the name of the currency dimension and the attribute that were selected in the very first interface where currency was selected. In another instance, if the measure group containing some of the selected measures or members is not dimensioned by the currency dimension selected in the drop down, then warning messages should be displayed such as: “The following measures or members <Measure/member1, Measure/member2 . . . > are not dimensioned by the currency dimension selected above. You can either go back to the measure/member selection page and remove those members or measures or add this currency dimension to their measure group dimensionality (through dimension usage view of Cube designer).” In yet another example, if a measure group dimensioned by an account typed dimension with an account type attribute is not using the selected currency dimension, then a blocking warning message can be displayed such as: “The <Selected dimension name> dimension is an invalid selection since it is not used by every measure group that use an account typed dimension with an account type attribute. Please select another dimension to hold your currency or make sure that every measure group using the account typed dimensions are also dimensioned by the dimension selected above . . . ” Selected dimension name is a token to be replaced with the name of that selected dimension in the drop done menu 712.

Interface 700b illustrates the instance where local currencies are selected as referenced by attributes in a dimension or dimension table. This is also referred to as the each entity option. Upon selection, window 714 is enabled and lists in tree view all the available dimension/attributes binded to the measure group. A user can select one single attribute. By default, all dimensions but the first one are collapsed. The first attribute of the first dimension is selected. Some settings can be detected automatically. For instance, if the fact table contains a currency symbol column, then the default selection for the currency association selection list can be “Each transaction in the fact table.” In addition, the many-to-one currency type selection can be selected by default. In addition, if the system detects a currency attribute with a dimension, then the default selection for the currency association can be “Each entity option.”

There can also be special cases with respect to selection of this option. For instance, if a measure group containing some of the selected measures or members is not dimensioned by the dimension selected in the list box, then a warning message can be displayed such as: “The following measures are not dimensioned by the currency dimension selected above. You can either go back to the measure/member selection page and remove those members or measures or add this selected dimension to their measure group dimensionality (through dimension usage vie of cube designer).” Additionally, if the measure group dimension by an account typed dimension with an account type attribute is not using the select currency dimension then a blocking warning message can be displayed such as: “The <Selected dimension name> dimension is an invalid selection since it is not used by every measure group that uses an account typed dimension with an account type attribute. Please select another dimension to hold your currency or make sure that every measure group using the account typed dimensions is also dimensioned by the dimension selected above . . . ” The selected dimension name is a token to be replaced with the name of the selected dimension in the drop down menu 712.

Finally, it should be noted that each of interfaces 700a and 700b can include navigational buttons 440. Such buttons can control movement back to the previous interface or page or forward to the next interface or page. Additionally, the cancel button can allow cancellation of the process.

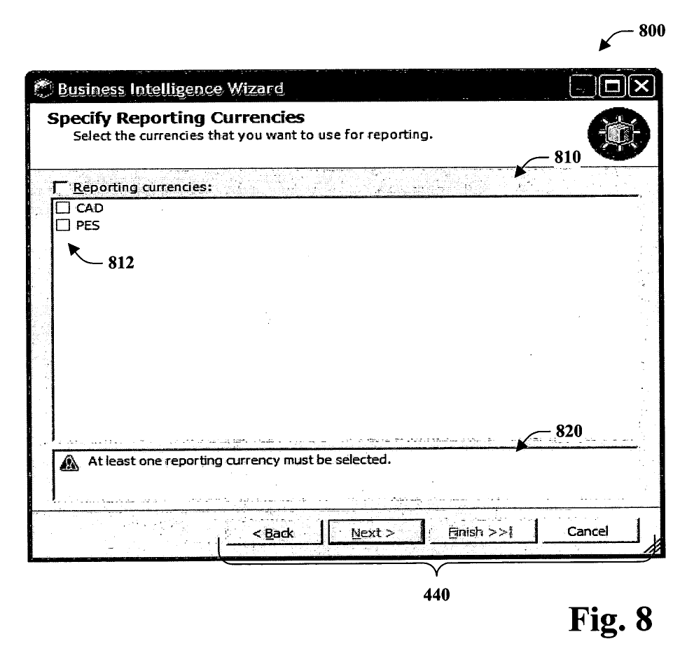

FIG. 8 illustrates an interface 800 to facilitate selection of one or more reporting currencies. Amongst other graphics, interface 800 can include a window 810 that includes a list of currencies available for selection. More particularly, the available currencies can correspond to the currency attribute of the currency dimension used by the rate measure group. By default, they are all unselected. The interface 800 can also include checkboxes 812 to enable reporting currencies to be selected. In addition, a window 820 can be provided to display messages such as “At least one reporting currency must be selected.” Finally, the interface 800 can include navigational buttons 440. As shown, only the back and cancel buttons are shown as no reporting currencies have been selected. Accordingly, at this point a user could elect to go back to the previous interface or page or cancel the process. Upon selection of one or more reporting currencies, the next and/or finish buttons can become active and selectable. The next button can move the wizard to the next page or interface if there is one or alternatively finish button can enable the generation of currency conversion infrastructure based on the specified parameters.

FIG. 9 depicts an exemplary graphical user interface 900 for dealing with existing script in accordance with an aspect of the subject invention. Interface 900 can be presented when an existing currency conversion script is detected. Interface 900 can include radio buttons 910 for selecting one of overwrite existing currency logic and append after the last existing currency logic. In addition, interface 900 can include a window or text box 920 that identifies the existing currency conversion script(s) and another window or text box 930 that identifies the new currency conversion script. This information can be helpful in determining whether to overwrite or append the new script. Finally, interface 900 can include navigational buttons to move to back to a previous interface or page, move forward to the next page, or finish the process.

Upon specification of currency conversion parameters the code the conversion component 120 (FIGS. 1 and 3) can generate some script calculations and potentially add a new currency dimension into the main cube. The following is a discussion and/or presentation of specific code or pseudo code generated by the conversion component 120 in response to particular specified parameters. It is being presented for purposes of clarity and understanding, and not limitation. Furthermore, the pseudo code is specified in MDX script but the subject invention is not limited to the form, syntax or semantics thereof as many other scripts could be utilized to provide the same functionality. In the MDX script of the following sections, the brackets “<” and “>” surround references to an object (e.g., dimension, attribute, member, operator . . . ) that has been specified or received through the interface component 110 including but not limited to the aforementioned wizard. Appendix A provides a list of a few tokens to facilitate understanding of the exemplary script that follows.

Furthermore, there are several different scopes that can be defined base on the parameters specified. For example, in the case where the specific measures option was selected the following tokens should be substituted with the specified tokenized script:
<Scope1: member selection>:
   Measures[<Selected measure 1>],Measures[<Selected measure 2>], . . . ,
      This list is made of each selected measures needing to be converted with the Measure rate “Rate Measure 1”
<Scope2: member selection>:
   Measures[<Selected measure 3>],Measures[<Selected measure 4>], . . . ,
      This list is made of each selected measures needing to be converted with the Measure rate “Rate Measure 2”

In the case where the specific accounts option was selected then the tokens should be substituted with the following specified tokenized script:
<Scope1: member selection>:
   [<AccountDimension>].[<Selected account 1>],
   [<AccountDimension>].[<Selected account 2>], . . . ,
   Except(Measures.Members, {Measures. [<Rate measure 1>], Measures. [<Rate measure 2>], . . . , Measures[<Rate measure n>]})
      This list is made of each selected measures needing to be converted with the Measure rate “Rate Measure 1”
<Scope2: member selection>:
   [<AccountDimension>].[<Selected account 3>],
   [<AccountDimension>].[<Selected account 4>], . . . ,
   Except(Measures.Members, {Measures. [<Rate measure 1>], Measures. [<Rate measure 2>], . . . , Measures. [<Rate measure n>]})
      This list is made of each selected measures needing to be converted with the Measure rate “Rate MeasureRate 2”

In the case where the specific account type option was selected, the following tokens should be substituted with the specified tokenized script:
<Scope1: member selection>:
   {Leaves ([<AccountDimension>].[<Accounttype>].[<Account type 1>]), Leaves ([<AccountDimension>].[<Accounttype>].[<Account type 2>]), . . . },
   Except(Measures.Members, {Measures[<Rate measure 1>], Measures.[<Rate measure 2>], . . . , Measures.[<Rate measure n>]})
      This list is made of each selected account types needing to be converted with the Measure rate “Rate Measure 1”
<Scope2: member selection>:
   {Leaves ([<AccountDimension>].[<Accounttype>].[<Account type 3>]), Leaves ([<AccountDimension>].[<Accounttype>].[<Account type 4>]), . . . },
   Except(Measures.Members, {Measures.[<Rate measure 1>], Measures.[<Rate measure 2>], . . . , Measures.[<Rate measure n>]})
      This list is made of each selected measures needing to be converted with the Measure rate “Rate MeasureRate 2”

Appendix B provides MDX script that is to be inserted at the beginning of the cube's MDX script. The script corresponds to a one-to-many type conversion and generates a new reporting currency dimension. This new dimension is made of the currencies selected in the reporting currency settings plus Pivot currency. Pivot currency is one to which the fact data are associated.

Appendix C provides MDX script that corresponds to the many-to-many type conversion and each transaction architecture. Two sub-cases are possible here. First, a currency dimension is already available for each measure group and this currency dimension is the one used by the rate group. In this case, this dimension is the one flagged (Dimension type) as either currency or source currency that was used to identify the reporting currency. Second, a currency dimension is already available for each measure group (e.g., flagged as currency or source currency) and this currency dimension is not the one used by the rate group. In addition, a reporting currency dimension is created. It is made of a distinct list of the pivot currency selected in the rate measure group step plus a “local” entry, the local entry is the one used to link to the fact table. All data in the fact of the measure group are associated to the local entry of the reporting currency dimension.

Appendix D provides MDX script that corresponds to a many-to-one conversion type each entity architecture. In this case, no new source currency dimension needs to be created. This is because each entity is already assumed to have its data in local currency. In addition, a new reporting currency dimension is created. It is made of a distinct list of the pivot currency selected in the Rate measure group step plus a local entry, the local entry is the one used to link to the fact table. All data in the fact of the measure group are associated to the local entry of the reporting currency dimension.

Appendix E presents MDX script that corresponds to a many-to-many type conversion each transaction architecture. There are two possible sub-cases here. First, a currency dimension is already available for each measure group and this currency dimension is the one used by the rate group. In this case, dimension is the one flagged (dimension type) as either currency or source currency that was used to identify the reporting currency. In a second case, a currency dimension is already available for each measure group (flagged as currency or source currency) and this currency dimension is not the one used by the rate group. In addition, this script generates a new reporting currency dimension. It is made of a distinct list of the currencies selected in the reporting currency settings and added to every measure group in the main cube plus the pivot currency selected in the rate measure group step and a local entry. The local entry is the one used to link to the fact table. All data in the fact of the measure group is associated to the local entry of the reporting currency dimension.

Appendix F provides MDX script corresponding to a many-to-many each entity architecture. Here, no source currency needs to be added, because each entity is already assumed to have its data in local currency. However, a new reporting currency dimension is created. It is made of a distinct list of the currencies selected in the reporting currency settings created and added to every measure group of the main cube, plus the pivot currency selected in the rate measure group step, and a local entry. The local entry is the one used to link to the fact table.

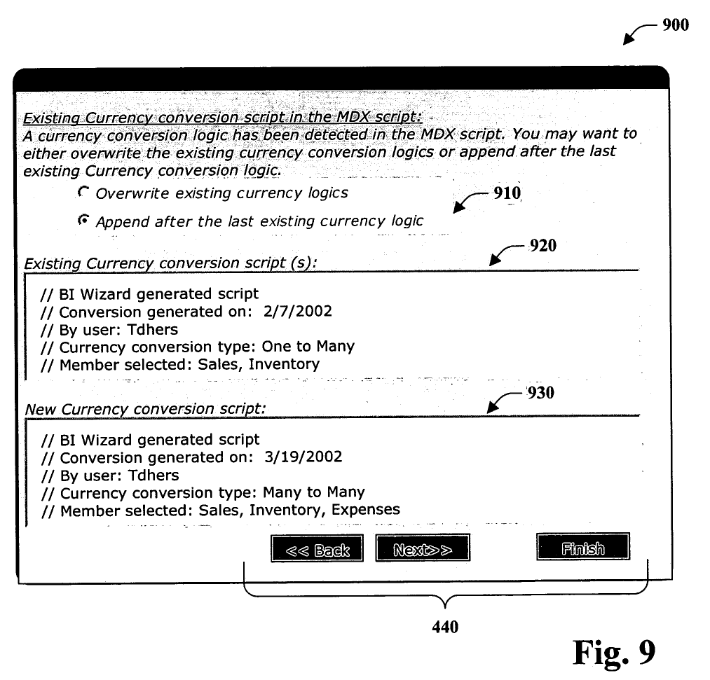

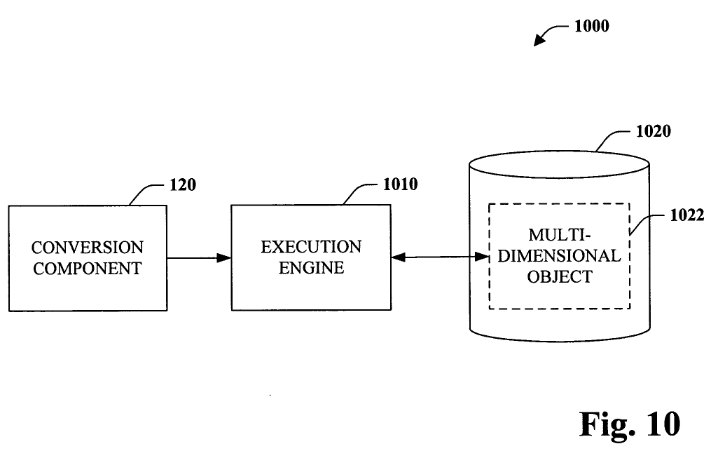

Turning to FIG. 10, a currency conversion system 1000 is depicted in accordance with an aspect of the subject invention. System 1000 includes conversion component 120, execution engine 1010, data store 1020, and multidimensional object 1022. The conversion component 120, execution engine 1010 and the data store 1220 can all reside on a server. Conversion component 120 can generate, among other things, commands or scripts for example in MDX, that provide the logic to generate a currency conversion supporting infrastructure. The script can be produced based on input from a user, for instance. The generated script or series of commands can be transmitted to an execution engine 1010. The execution engine 1010 can execute the script with respect to data store 1020. The data store 1020 can be any computer readable medium operable to store data. In particular, data store 1020 could correspond to a multidimensional database or a relational database modeled as a multidimensional database. Data store 1020 can include multidimensional objects 1022. Multidimensional objects can include but are not limited to one or more cubes and/or attributes or properties thereof. Execution engine 1010 can execute script provided by conversion component 120 to augment a multidimensional object to support currency conversion. For example, one or more cube dimension and/or data source views could be created and populated.

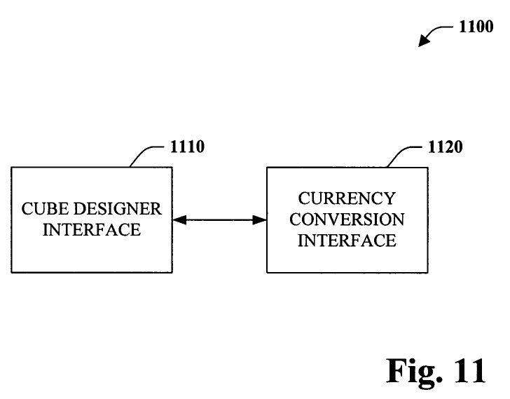

FIG. 11 depicts an interface system 1100 in accordance with an aspect of the subject invention. The one or more currency conversion systems described supra could be integrated into other systems. For example, the currency systems could form part of a larger cube generation or update system. Interface system 1100 facilitates such interaction. System 1100 can include a cube design interface component 1110 and a currency conversion interface 1120. Cube design interface component 1110 can be associated with a larger cube design or update system or method. Currency conversion interface 1120 can be associated with a currency conversion system such as that described by system 100 of FIG. 1. Interface 1110 and 1120 can be communicatively coupled. Accordingly, they can transmit amongst themselves in data packets, for instance. Furthermore, interface component 1110 can provide a signal or command to currency conversion interface 1120. Upon receipt of the signal, currency conversion functionality could be initiated. Upon completion, interface component 1120 could provide a signal that it is complete. In this manner, the functionality provided by currency conversion systems described herein can be incorporated into a larger system providing more diverse and comprehensive functionality.

The aforementioned systems have been described with respect to the interaction between several components. It should be appreciated that such systems can include those components specified therein, some of the specified components, and/or additional components specified in other systems. For example, interface component 110 can include a rate component 210, a member component 220, a conversion type component 230, a reporting currency component 240, a local currency component 250 or any combination thereof. Additionally, it should be noted that one or more components may be combined into a single component providing aggregate functionality or divided into several subcomponents. The components may also interact with or be integrated with one or more other components or systems not specifically described herein but known by those of skill in the art.

Furthermore, as will be appreciated by artisans of ordinary skill in this field, various portions of the disclosed systems above and methods below may include or consist of artificial intelligence or knowledge based components, sub-components, processes, means, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as well as efficient. For example, many components could infer (as that term is defined herein) information to facilitate conversion from other information, data, or context rather than requesting specific information from a user or other source, for instance,

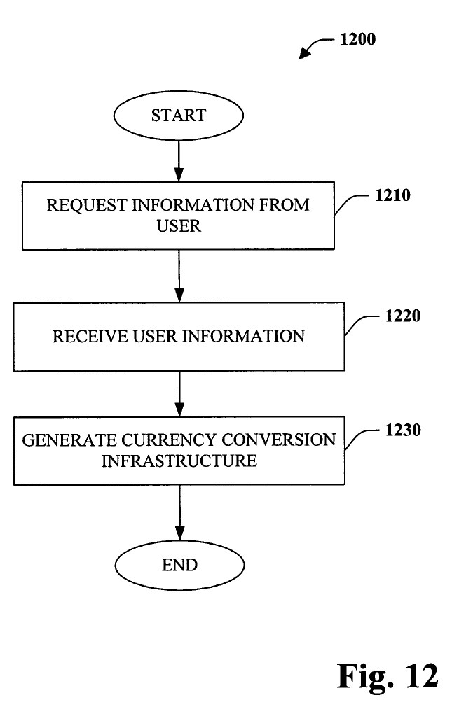

In view of the exemplary systems described supra, methodologies that may be implemented in accordance with the present invention will be better appreciated with reference to the flow charts of FIGS. 12-14. While for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from what is depicted and described herein. Moreover, not all illustrated blocks may be required to implement the methodology in accordance with the present invention.

Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning to FIG. 12, a currency conversion methodology 1200 is illustrated in accordance with an aspect of the subject invention. At reference numeral 1210, currency conversion information is requested from a user. Such requests can be presented and requested in business terms rather than bogging a user down with technical details of the implementation. In accordance with an aspect of the subject invention, a user can be queried utilizing a wizard or a series of interfaces or graphical pages to request information in an ordered fashion. At 1220, the information requested from the user is received or retrieved. At 1230, the received information is utilized to generate an infrastructure for supporting currency conversion. In particular, cube scripts (e.g., in MDX) can be generated in accordance with the received information or currency conversion parameters providing conversion logic. In addition, dimensions could be added to a cube and new data source views produced, among other things.

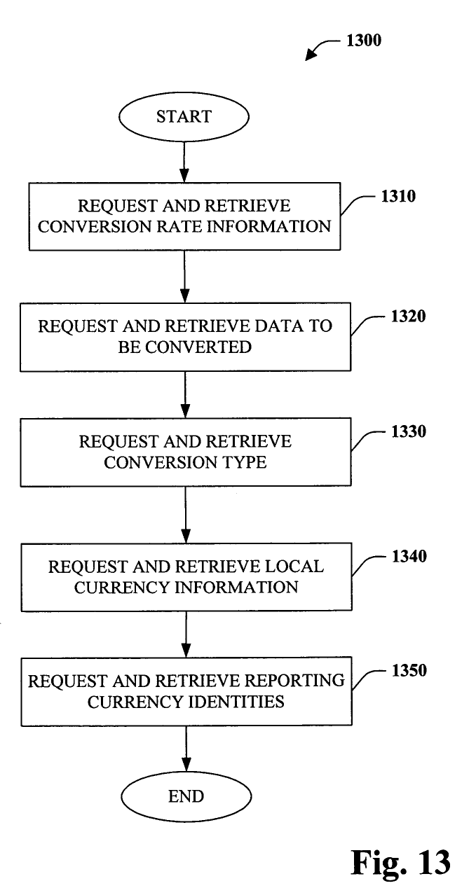

FIG. 13 depicts an interface methodology 1300 in accordance with an aspect of the subject invention. In order to generate the infrastructure to support multidimensional database currency conversions particular information or parameters need to be retrieved. At 1310, currency conversion or exchange rates information can be requested and retrieved. Such information can include the location of the exchange rate. This location can be from within a cube such as a measure group or external thereto. For example, the location can be pointer or reference to a web service. In addition, the base of the currency as well as whether the target currency should be multiplied or divided by the exchange rate will need to be retrieved to facilitate triangulation, which is a method of currency conversion. At 1320, the identity of the data to be converted is requested and retrieved. This can include cube members such as a measure dimension or an account hierarchy. At 1330, the type of conversion can be requested and retrieved. For example, such conversion types can include but are not limited to many-to-one, one-to-many, and many-to-many. Many-to-one conversion pertains to converting a plurality of currencies into one such as a number of local currencies to one corporate currency. One-to-many conversion concerns translating one currency to a myriad of currencies. Many-to-many is a combination many-to-one and one-to-many. Here a number of currencies are translated into a number of other currencies. At 1340, local currency information is requested and retrieved. Such information can specify how local currency is references. This is needed when the conversion type is one-to-many or many-to-one. The local currency can be referenced by transaction or based on the origin of the transaction. For example, a currency code can be associated with each transaction. More specifically, the currency code can be associated with transactions in the fact table. Alternatively, currency can be referenced based on the origin such as a dimension attribute. At 1350, reporting currency information can be requested and retrieved. This information can be required when the conversion type is one-to-many or many-to-many. In essence, one or more currencies are being translated to several other reporting currencies. Accordingly, these reporting currencies should be identified.

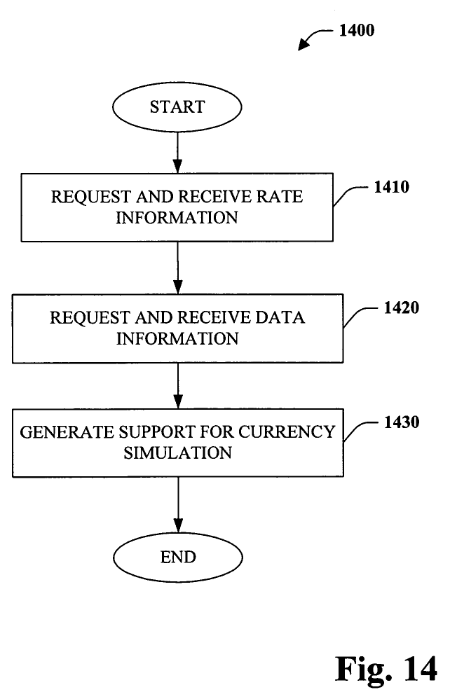

FIG. 14 is a currency conversion methodology 1400 in accordance with an aspect of the subject invention. More particularly, methodology 1400 concerns currency simulation. At 1410, rate information can be requested and/or received. This information can include the value or location of a plurality of exchanges rates. Such rates can be a current rate, a past rate, a budgeted rate, and/or an anticipated rate. In a basic system, a single rate is requested and/or received and applied. Here, multiple rates are received to facilitate comparison thereof, for example, in cash flow simulations. At 1420, data information is requested and/or received. Data information pertains to the data or identity thereof, for example members/measures, on which the rates will be applied. At 1230, support for currency simulation will be generated. Such support can include creation of one or more dimensions, for example, including data converted into multiple currencies. Furthermore, data source views can be created to facilitate viewing and querying such data. This infrastructure can be generated by a script such as MDX script.

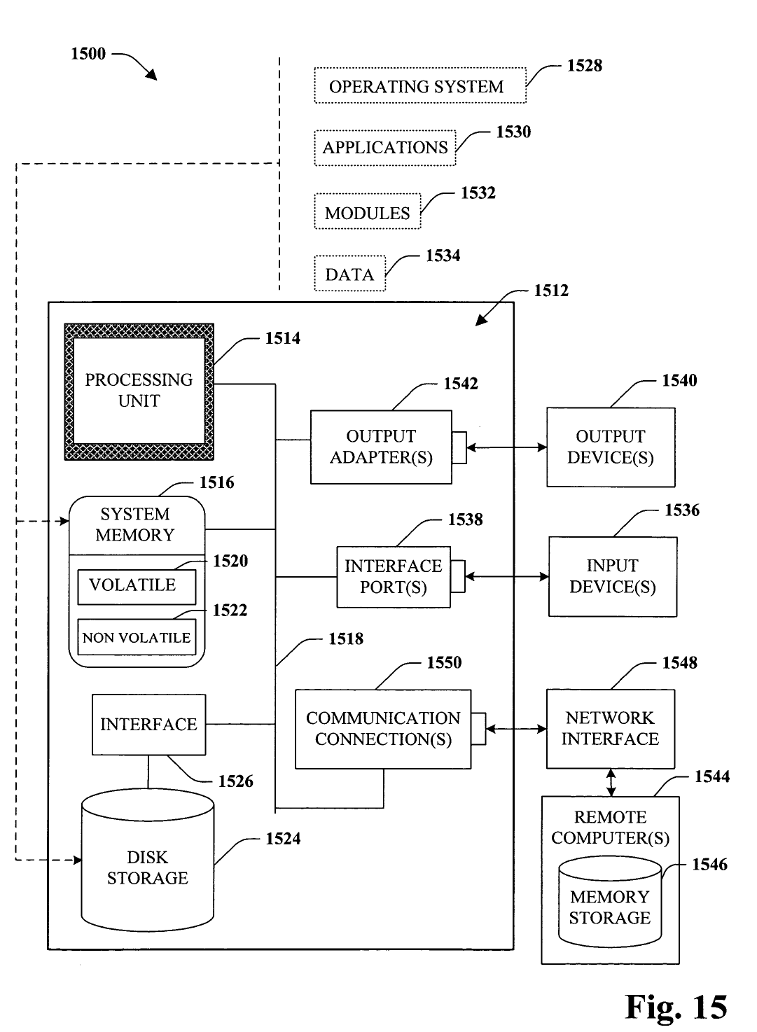

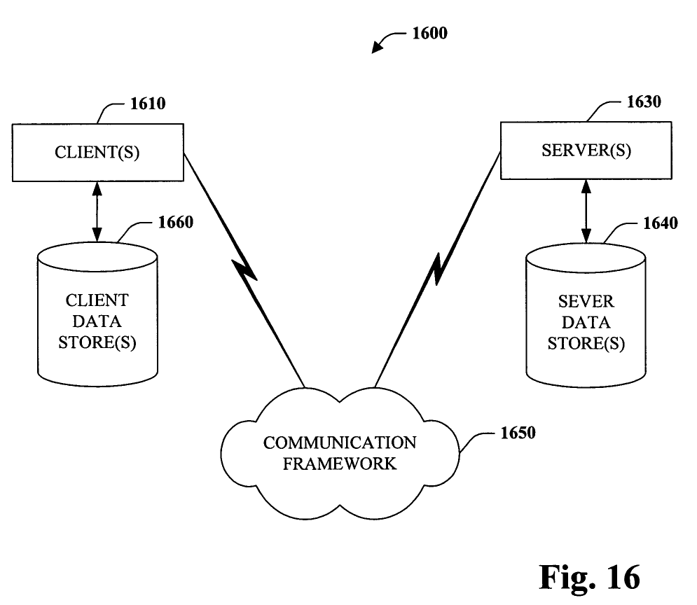

In order to provide a context for the various aspects of the invention, FIGS. 15 and 16 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 15, an exemplary environment 1500 for implementing various aspects of the invention includes a computer 1512. The computer 1512 includes a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514.

The system bus 1518 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1516 includes volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include read only memory (ROM), programmable ROM (PROM), electrically programmable ROM (EPROM), electrically erasable ROM (EEPROM), or flash memory. Volatile memory 1520 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1512 also includes removable/non-removable, volatile/non-volatile computer storage media. FIG. 15 illustrates, for example disk storage 1524. Disk storage 4124 includes, but is not limited to, devices like a magnetic disk drive, floppy disk drive, tape drive, Jaz drive, Zip drive, LS-100 drive, flash memory card, or memory stick. In addition, disk storage 1524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1524 to the system bus 1518, a removable or non-removable interface is typically used such as interface 1526.

It is to be appreciated that FIG. 15 describes software that acts as an intermediary between users and the basic computer resources described in suitable operating environment 1510. Such software includes an operating system 1528. Operating system 1528, which can be stored on disk storage 1524, acts to control and allocate resources of the computer system 1512. System applications 1530 take advantage of the management of resources by operating system 1528 through program modules 1532 and program data 1534 stored either in system memory 1516 or on disk storage 1524. It is to be appreciated that the present invention can be implemented with various operating systems or combinations of operating systems.

A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port may be used to provide input to computer 1512 and to output information from computer 1512 to an output device 1540. Output adapter 1542 is provided to illustrate that there are some output devices 1540 like displays (e.g., flat panel and CRT), speakers, and printers, among other output devices 1540 that require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a personal computer, a server, a router, a network PC, a workstation, a microprocessor based appliance, a peer device or other common network node and the like, and typically includes many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1550 refers to the hardware/software employed to connect the network interface 1548 to the bus 1518. While communication connection 1550 is shown for illustrative clarity inside computer 1512, it can also be external to computer 1512. The hardware/software necessary for connection to the network interface 1548 includes, for exemplary purposes only, internal and external technologies such as, modems including regular telephone grade modems, cable modems, power modems and DSL modems, ISDN adapters, and Ethernet cards.

FIG. 16 is a schematic block diagram of a sample-computing environment 1600 with which the present invention can interact. The system 1600 includes one or more client(s) 1610. The client(s) 1610 can be hardware and/or software (e.g., threads, processes, computing devices). The system 1600 also includes one or more server(s) 1630. The server(s) 1630 can also be hardware and/or software (e.g., threads, processes, computing devices). The server(s) 1630 can house threads to perform transformations by employing the present invention, for example. One possible communication between a client 1610 and a server 1630 may be in the form of a data packet transmitted between two or more computer processes. The system 1600 includes a communication framework 1650 that can be employed to facilitate communications between the client(s) 1610 and the server(s) 1630. The client(s) 1610 are operatively connected to one or more client data store(s) 1660 that can be employed to store information local to the client(s) 1610. Similarly, the server(s) 1630 are operatively connected to one or more server data store(s) 1640 that can be employed to store information local to the servers 1630.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the terms “includes,” “has,” and “having” are used in either the detailed description or the claims, such term is intended to be inclusive in a manner similar to the term “comprising” as “comprising” is interpreted when employed as a transitional word in a claim.

What is claimed is:

1. A currency conversion system comprising:
an interface component that requests and receives currency data in business terms; and
a conversion component that receives the currency data and generates supporting infrastructure for currency conversion with respect to a multidimensional database.

2. The system of claim 1, the conversion component generates one or more multidimensional data cube scripts.

3. The system of claim 2, the script generated is MDX.

4. The system of claim 1, the conversion component generates a new data source view.

5. The system of claim 1, the interface component comprises a wizard to request and received data.

6. The system of claim 5, the interface component requests and receives a reference to one or more exchange rates, pivot currencies, and application rules.

7. The system of claim 6, the interface component requests and receives the identity of one or more data units to be converted.

8. The system of claim 7, the interface component requests and receives the conversion type that includes one of many-to-one, one-to-many, and many-to-many.

9. The system of claim 8, the interface component requests and receives a local currency reference that identifies the manner in which currency information is specified with respect to data.

10. The system of claim 9, the interface component requests and receives reporting currencies to be employed.

11. A data cube design system comprising:
means to request and receive currency conversion information in business terms; and
means for generating multidimensional cube infrastructure to support triangulation in accordance with the received conversion information.

12. A currency conversion method comprising:
requesting conversion information from a user in business terms;
receiving the information; and
generating currency conversion infrastructure based on the received information.

13. The method of claim 12, requesting conversion information comprises requesting a reference to one or more exchange rates, pivot currencies, and application rules.

14. The method of claim 13, requesting conversion information comprises requesting a reference to one or more data units to be converted.

15. The method of claim 14, requesting conversion information comprises requesting a conversion type that includes one of many-to-one, one-to-many, and many-to-many.

16. The method of claim 15, requesting conversion information comprises requesting a local currency reference that identifies the manner in which currency information is specified with respect to data.

17. The method of claim 15, requesting conversion information comprises requesting identification of reporting currencies.

18. The method of claim 12, generating currency conversion infrastructure comprises generating currency logic in MDX script.

19. The method of claim 12, generating currency conversion infrastructure comprises generating a new cube dimension for conversion data.

20. The method of claim 19, further comprising generating a new data source view for the dimension.
